(19) United States
(12) Patent Application Publication
(10) Pub. No.: US 2024/0124992 A1
(43) Pub. Date: Apr. 18, 2024

(54) NOVEL NICKEL FOAM HAVING HIERARCHICAL PORE STRUCTURE, METHOD OF PRODUCING THE SAME, AND APPLICATION THEREOF

(71) Applicant: Daegu Gyeongbuk Institute of Science and Technology, Daegu (KR)

(72) Inventors: Jong-Sung YU, Seoul (KR); Yi WEI, Daegu (KR)

(73) Assignee: Daegu Gyeongbuk Institute of Science and Technology, Daegu (KR)

(21) Appl. No.: 18/488,479

(22) Filed: Oct. 17, 2023

(30) Foreign Application Priority Data
Oct. 17, 2022 (KR) 10-2022-0133173

(51) Int. Cl. C25B 11/031; B01D 53/86; B01J 23/72; B01J 23/755; B01J 35/56; B01J 35/61; C23F 1/12; C25B 1/04; C25B 11/061; H01G 11/30; H01G 11/52

(52) U.S. Cl. CPC C25B 11/031; B01D 53/8609; B01D 53/8628; B01J 23/72; B01J 23/755; B01J 35/56; B01J 35/612; C23F 1/12; C25B 1/04; C25B 11/061; H01G 11/30; H01G 11/52; B01D 2255/20761; B01D 2255/9155; B01D 2257/302; B01D 2257/404

(57) ABSTRACT

Provided are a novel nickel foam having a hierarchical pore structure, a method of producing the same, and an application thereof. Unlike a conventional nickel foam, the nickel foam has a well-developed hierarchical pore structure including pores having a size of 4 μm or less in addition to inherent macropores having a size of 100 μm to 900 μm, and thus, may have a significantly large specific surface area. Accordingly, the nickel foam may be variously applied to an electrochemical reaction such as a water electrolysis system and an exhaust gas purification filter.

### CROSS-REFERENCE TO RELATED APPLICATION

This application claims priority under 35 U.S.C. § 119 to Korean Patent Application No. 10-2022-0133173, filed on Oct. 17, 2022, in the Korean Intellectual Property Office, the disclosure of which is incorporated herein by reference in its entirety.

### TECHNICAL FIELD

The following disclosure relates to a novel nickel foam having a hierarchical pore structure, a method of producing the same, and an application thereof.

### BACKGROUND

Since a nickel foam (NF) is commercially available at a reasonable price and has high porosity, flexibility, and electroconductivity, it is variously used as a catalyst carrier, a current collector for an electrode, and the like.

In particular, since the nickel foam is appropriate for supporting an active metal catalyst of various electrochemical reactions including a water electrolysis reaction due to its three-dimensional pore structure, it is a highly usable structure. Furthermore, since the nickel foam may directly support an active metal catalyst without using a binder which is usually used for depositing an active metal catalyst in a powder form on a conductive substrate, it is widely used in an electrochemical field.

However, since a currently used nickel foam has inherent macropores having a size of 100 μm to 900 μm, it has a small surface area and thus, its electrochemical performance to be achieved is limited.

Non-Patent Document 1 discloses a method of producing a nickel foam having pores having a size of tens of μm for improving the surface area of the nickel foam. However, it is how a polymer is produced using a template, and since a process of producing/removing a polymer is essential, complexity of the process is increased.

### RELATED ART DOCUMENTS

### Non-Patent Documents

(Non-patent Document 1) J. Manuf. Sci. Eng. April 2014, 136(2): 021002

### SUMMARY

An embodiment of the present disclosure may be realized by providing a novel nickel foam having a hierarchical pore structure and a method of producing the same.

Another embodiment of the present disclosure may be realized by providing a supercapacitor including a nickel foam having a hierarchical pore structure as a current collector for an electrode.

Another embodiment of the present disclosure may be realized by providing a catalyst including the nickel foam having a hierarchical pore structure.

Still another embodiment of the present disclosure may be realized by providing a water electrolysis system and an exhaust gas purification filter including the catalyst.

In one general aspect, a nickel foam which has a peak at 397.4±1.0 eV in a spectrum by X-ray photoelectron spectroscopy and has a hierarchical pore structure including two or more discontinuous pore distribution peaks in a pore size distribution measured by mercury intrusion porosimetry is provided.

In an exemplary embodiment, the nickel foam may have a water contact angle of 80° or less on a surface.

In an exemplary embodiment, the nickel foam may have a specific surface area of 0.1 m²/g or more.

In an exemplary embodiment, the two or more pore distribution peaks may include a first peak having an average pore size between 100 μm and 900 μm and a second peak having an average pore size between 400 nm and 4000 nm.

In an exemplary embodiment, the two or more pore distribution peaks may further include a third peak having an average pore size between 100 nm and 300 nm.

In an exemplary embodiment, the nickel foam may have pores generated on a skeleton, which have an average diameter 25 times or more smaller than an average diameter of inherent macropores of the nickel foam.

In an exemplary embodiment, the pores generated on the skeleton of the nickel foam may include open pores.

In another general aspect, a catalyst includes: a nickel foam; and a transition metal supported on the surface of the nickel foam.

In an exemplary embodiment, the catalyst may have a use in an oxygen evolution reaction (OER) or a use in a hydrogen evolution reaction (HER).

In an exemplary embodiment, the transition metal may be any one or two or more metals selected from the group consisting of group 4 to 12 metals.

In another general aspect, a water electrolysis system includes a reaction unit where a water electrolysis reaction occurs, wherein the reaction unit includes a negative electrode, a positive electrode, and an electrolyte, and any one or more of the negative electrode and the positive electrode include the catalyst according to an exemplary embodiment described above.

In an exemplary embodiment, the electrolyte may be an alkaline aqueous solution or a neutral aqueous solution.

In an exemplary embodiment, a hydrogen storage unit where hydrogen generated by the water electrolysis reaction is stored may be further included.

In another general aspect, an exhaust gas purification filter includes: a filter unit including the catalyst according to an exemplary embodiment described above; an inlet provided in one side of the filter unit to which gas including harmful exhaust gas is introduced; and an outlet provided in the other side of the filter unit from which gas from which the harmful exhaust gas has been removed is discharged.

In another general aspect, a supercapacitor includes: a negative electrode, a positive electrode, a separator interposed between the negative electrode and the positive electrode, and an electrolyte, wherein any one or more of the negative electrode and the positive electrode include the nickel foam according to an exemplary embodiment described above.

In still another general aspect, a method of producing a nickel foam having a hierarchical pore structure includes: a first step of charging a nickel foam into a reactor; and a second step of heating the reactor to a temperature of 300° C. or higher and introducing an etching gas to react the nickel foam.

In an exemplary embodiment, the etching gas may be a nitrogen-containing gas.

In an exemplary embodiment, the nitrogen-containing gas may be basic in a solution.

In an exemplary embodiment, the nitrogen containing gas may be ammonia.

In an exemplary embodiment, the heating may be performed to a temperature of 600° C. to 1,100° C.

In an exemplary embodiment, the etching gas may be introduced to the reactor at a flow rate of 100 sccm to 500 sccm.

Other features and aspects will be apparent from the following detailed description, the drawings, and the claims.

### BRIEF DESCRIPTION OF THE DRAWINGS

FIG. 1 is a schematic diagram showing a synthesis process of a nickel foam according to an exemplary embodiment having a hierarchical pore structure.

FIG. 2 is SEM images of nickel foams according to Comparative Example 1 and Example 1.

FIG. 3 is enlarged SEM images of skeleton parts of the nickel foams according to Comparative Example 1 and Example 1.

FIGS. 4 to 7 are FIBICC images taken to confirm whether the nickel foams of Comparative Example 1 and Example 1 include open pores.

FIG. 8 is a drawing showing pore size distributions of the nickel foams of Comparative Example 1 and Example 1.

FIGS. 9 to 11 are spectra by X-ray photoelectron spectroscopy (XPS) of the nickel foams according to Comparative Example 1 and Example 1.

FIGS. 12 and 13 are SEM images and OER catalytic activity curves of a nickel foam produced by treatment with ammonia gas at various temperatures for 1 hour, respectively.

FIG. 14 is SEM images of a nickel foam produced by treatment with ammonia gas at 700° C. at different times.

FIG. 15 is a graph showing a treatment time range depending on a temperature where the nickel foam having a hierarchical pore structure may be produced.

FIG. 16 are SEM images of nickel foams produced according to Comparative Examples 4, 5, and 6.

FIG. 17 is XRD patterns of Fe-hNF, Fe-NF, the nickel foam of Example 1 and the nickel foam of Comparative Example 1.

FIG. 18 is a photograph of Fe-hNF, Fe-NF, the nickel foam of Example 1 and the nickel foam of Comparative Example 1.

FIGS. 19 and 20 are SEM images of Fe-NF and Fe-hNF, respectively.

FIGS. 21 and 22 are SEM images and OER catalytic activity curves of Fe-supported nickel foams produced at different concentrations of an iron precursor solution in the nickel foam of Example 1, respectively.

FIG. 23 is digital photographs taken after dropping water droplets on surfaces of the nickel foam of Comparative Example 1, the nickel foam of Example 1, Fe-NF, and Fe-hNF.

FIG. 24 is OER catalytic activity curves of Fe-hNF, Fe-NF, the nickel foam of Comparative Example 1, the nickel foam of Example 1, and the nickel foam catalyst on which iridium oxide powder was supported.

FIG. 25 is a graph showing a current density difference at 1.074 V (vs. RHE) depending on a scan speed.

FIG. 26 is Tafel plots of the nickel foam of Comparative Example 1, the nickel foam of Example 1, Fe-NF, and Fe-hNF.

FIG. 27 is an electrochemical impedance graph of the nickel foam of Comparative Example 1, the nickel foam of Example 1, Fe-NF, and Fe-hNF.

FIGS. 28 to 30 are drawings showing the results of a stability test performed by chronopotentiometric measurement.

FIG. 31 is a graph showing a current density difference at 1.11 V (vs. RHE) depending on a scan speed.

FIG. 32 is an LSV graph for the nickel foams of Comparative Example 1 and Example 1, and FIG. 33 is a Tafel plot of the nickel foams of Comparative Example 1 and Example 1.

FIG. 34 is an Arrhenius plot of the nickel foams of Comparative Example 1 and Example 1.

FIG. 35 is SEM images of Pt-25.0-hNF and Pt-25.0-NF according to Experimental Example 9.

FIGS. 36 to 39 are HER catalytic activity curves depending on concentrations of platinum used.

FIGS. 40 to 42 are an LSV graph, a Tafel plot, and a graph of activity per weight for Pt-12.5-hNF, Pt-12.5-NF, and commercial Pt/C (20%), respectively.

FIGS. 43 and 44 are a drawing showing experiment conditions for doping the nickel foam produced according to Example 1 with copper (Cu) and SEM images of Cu-hNF produced therefrom, respectively.

### DETAILED DESCRIPTION OF EMBODIMENTS

The embodiments described in the present specification may be modified in many different forms, and the technology according to an exemplary embodiment is not limited to the embodiments set forth herein. In addition, the embodiments of an exemplary embodiment are provided so that the present disclosure will be described in more detail to a person with ordinary skill in the art.

In addition, the singular form used in the specification and claims appended thereto may be intended to include a plural form also, unless otherwise indicated in the context.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in the specification of the present disclosure, values which may be outside a numerical range due to experimental error or rounding off of a value are also included in the defined numerical range.

Furthermore, throughout the specification, unless explicitly described to the contrary, “comprising” any constituent elements will be understood to imply further inclusion of other constituent elements.

Since a conventional nickel foam has only inherent macropores having a size of 100 μm to 900 μm, it has a small surface area and thus, electrochemical performance to be achieved is limited.

Thus, the inventors of the present disclosure repeated studies for a nickel foam which may contribute to excellent electrochemical performance, and as a result, found that a nickel foam which has a well-developed hierarchical pore structure further including pores having a size of 4 μm or less in addition to inherent macropores having a size of 100 μm to 900 μm, and thus, has a significantly large specific surface area may be provided, thereby completing the present disclosure.

The nickel foam according to an exemplary embodiment of the present disclosure is characterized by having a peak at 397.4±1.0 eV in a spectrum by X-ray photoelectron spectroscopy and having a hierarchical pore structure including two or more discontinuous pore distribution peaks in a pore size distribution measured by mercury intrusion porosimetry.

Since the nickel foam has the characteristics described above, it may have not only a hydrophilic surface to improve a contact with an electrolyte in an electrochemical reaction, but also a hierarchical pore structure further including pores having a size of 4 μm or less in addition to macropores having a size of 100 μm to 900 μm. Accordingly, the nickel foam according to an exemplary embodiment may be used as a support of a catalyst or a current collector for an electrode and be used in a catalyst having excellent electrochemical performance or electrode materials.

Specifically, the nickel foam has a peak at 397.4±1.0 eV in a N is spectrum by X-ray photoelectron spectroscopy, and the peak shows Ni-N binding energy. That is, the nickel foam may have a hydrophilic surface by nitrogen doped on the surface. The hydrophilicity of the nickel foam may improve a contact with an electrolyte in the electrochemical reaction, and, in particular, is a characteristic of greatly accelerating bubble separation as well as the contact with an electrolyte in the electrochemical reaction in which bubbles occur, such as an oxygen evolution reaction or a hydrogen evolution reaction. Thus, as the nickel foam has hydrophilicity, an effective active surface area involved in the electrochemical reaction may be improved to improve electrochemical performance.

In an exemplary embodiment, a water contact angle on the surface of the nickel foam may be 80° or less, specifically 75° or less, more specifically 70° or less, and more specifically 65° or less. The lower limit of the water contact angle is not particularly limited, and, as an example, may be 0° or 10°. As the nickel foam satisfies the water contact angle in the range described above, when it is applied to an electrochemical reaction, an effective contact with an electrolyte may be caused. In particular, when the nickel foam is applied to an electrochemical reaction in which bubbles occur, such as an oxygen evolution reaction or a hydrogen evolution reaction, bubble separation as well as the contact with an electrolyte may be greatly accelerated to eventually improve the electrochemical performance.

In an exemplary embodiment, the water contact angle may be measured using a contact angle measuring instrument, and specifically, may be measured using a contact angle measuring instrument in accordance with ASTM D5946.

In an exemplary embodiment, the nickel foam may have a specific surface area of 0.1 m²/g or more. Specifically, the nickel foam may have a specific surface area of 0.15 m²/g or more, 0.2 m²/g or more, or 0.25 m²/g or more, and the upper limit is not particularly limited, but, as an example, may be 2.0 m²/g or 1.0 m²/g.

Since the nickel foam according to an exemplary embodiment has a hierarchical pore structure including two or more discontinuous pore distribution peaks in a pore size distribution measured by mercury intrusion porosimetry, it may have a large specific surface area contributing to an excellent electrochemical reaction. Unlike a conventional nickel foam having only inherent macropores having a size of specifically 100 μm to 900 μm, the nickel foam has a well-developed hierarchical pore structure further including pores having a size of 4 μm or less in addition to the macropores, and thus, may have a significantly large specific surface area.

In an exemplary embodiment, the two or more pore distribution peaks may include a first peak having an average pore size between 100 μm and 900 μm and a second peak having an average pore size between 400 nm and 4000 nm.

In an exemplary embodiment, the first peak may have an average pore size between 100 μm and 900 μm, specifically between 100 μm and 500 μm, and more specifically between 100 μm and 300 μm.

In an exemplary embodiment, the second peak may have an average pore size between 400 nm and 4000 nm, specifically between 400 nm and 2000 nm, more specifically between 400 nm and 1000 nm, and still more specifically between 500 nm and 700 nm.

In an exemplary embodiment, the two or more pore distribution peaks may further include a third peak having an average pore size between 100 nm and 300 nm, and thus, have a larger specific surface area, and when the nickel foam is applied to an electrochemical reaction, an electrochemically active area may be greatly increased and a material diffusion rate may be increased to improve electrochemical performance.

In an exemplary embodiment, the nickel foam may have pores generated on the skeleton, which have an average diameter 25 times or more smaller than the average diameter of the inherent macropores of the nickel foam, and the pores generated may have an average diameter specifically 50 times or more smaller, and more specifically 100 times or more smaller. Herein, the macropores refer to pores of a conventional nickel foam, and specifically, may refer to pores having an average diameter of 100 μm to 900 μm.

In an exemplary embodiment, the pores generated on the skeleton of the nickel foam may include open pores. Since the nickel foam includes open pores, it may have a larger specific surface area and also may derive efficient diffusion of a reactant and a product in an electrochemical reaction, and thus, may implement significantly better electrochemical performance.

In an exemplary embodiment, the open pores may be included at 50% or more, specifically 60% or more, 70% or more, 80% or more, or 85% or more and 99% or less or 95% or less of the pores generated on the skeleton of the nickel foam.

In an exemplary embodiment, the open pores may include those interconnected inside the skeleton of the nickel foam, thereby having a larger specific surface area, and also, may derive efficient diffusion of a reactant and a product in an electrochemical reaction to implement significantly better electrochemical performance.

An exemplary embodiment provides a catalyst including: the nickel foam described above; and a transition metal supported on a surface of the nickel foam, and the catalyst may have significantly improved catalytic activity by including the nickel foam described above.

In an exemplary embodiment, the catalyst may have a use in an oxygen evolution reaction (OER) or a use in a hydrogen evolution reaction (HER), and since the catalyst including the nickel foam described above having excellent hydrophilicity and a hierarchical pore structure is used in the oxygen evolution reaction or the hydrogen evolution reaction, electrochemical catalytic activity may be significantly improved.

Specifically, the catalyst may show low overvoltage for the hydrogen evolution reaction and the oxygen evolution reaction, and, in particular, may show significantly low overvoltage even at a current density of 100 mA/cm² or more, 300 mA/cm² or more, or 500 mA/cm². In addition, since the low overvoltage may be maintained for 5 hours or more or 10 hours or more, the catalyst is excellent in terms of stability. In addition, since the catalyst has a characteristic of a significantly large electrochemically active area, it may implement significantly improved electrochemical catalytic activity.

In an exemplary embodiment, the transition metal is not particularly limited, but may be any one or two or more metals selected from the group consisting of group 3 to 12 metals. Specifically, it may be any one or two or more metals selected from the group consisting of Groups 4 to 12, 6 to 11, 8 to 11, or 8 to 10, but is not particularly limited thereto.

For example, the transition metal may be any one or two or more metals selected from the group consisting of Ti, Zr, Fe, Ru, Co, Ir, Ni, Pt, Cu, Ag, Au, and Zn.

In an exemplary embodiment, the transition metal may be supported at 0.01 parts by weight to 10 parts by weight, specifically 0.05 parts by weight to 5 parts by weight with respect to 100 parts by weight of the nickel foam, and since the transition metal is supported in the range described above, it may be prevented from blocking the pores of the nickel foam to maximize catalytic activity.

In an exemplary embodiment, supporting the transition metal on the nickel foam may be performed without limitation by a method known to a person skilled in the art, and electrochemical deposition, hydrothermal synthesis, solvent thermal synthesis, atomic layer deposition (ALD), chemical vapor deposition (CVD), and the like may be exemplified.

A water electrolysis system according to an exemplary embodiment includes a reaction unit in which a water electrolysis reaction occurs, the reaction unit includes a negative electrode, a positive electrode, and an electrolyte, and any one or more of the negative electrode and the positive electrode may include the catalyst described above.

In an exemplary embodiment, the water electrolysis system may further include a hydrogen storage unit in which hydrogen generated by the water electrolysis reaction is stored, and the hydrogen storage unit is used in a common water electrolysis system. For example, hydrogen stored in the hydrogen storage unit may be stored in a cryogenic state at a level of about 38 K.

The water electrolysis system may greatly increase an electrochemically active area and increase a material diffusion rate to improve electrochemical performance, by using the catalyst having significantly improved catalytic activity described above in the negative electrode and/or the positive electrode.

In an exemplary embodiment, the electrolyte may be an alkaline aqueous solution or a neutral aqueous solution. Since there is almost no catalyst satisfying both of catalytic activity and stability for the oxygen evolution reaction and the hydrogen evolution reaction in an electrolyte of a strong acid, an alkaline or neutral electrolyte is used, but an alkaline electrolyte has a demerit of showing high overvoltage to, in particular, an oxygen evolution reaction due to a slow reaction rate. However, the water electrolysis system uses the catalyst having significantly improved catalytic activity in a negative electrode and/or positive electrode, thereby implementing significantly improved electrochemical performance even in an alkaline or neutral aqueous solution.

The exhaust gas purification filter according to an exemplary embodiment may include a filter unit including the catalyst described above; an inlet provided in one side of the filter unit to which gas including harmful exhaust gas is introduced; and an outlet provided in the other side of the filter unit from which gas from which the harmful exhaust gas has been removed is discharged.

In an exemplary embodiment, the harmful exhaust gas may be nitrogen oxides (NOₓ) which are any one or more selected from nitrogen monoxide (NO), nitrogen dioxide (NO₂), and ions thereof, or sulfur oxides (SOₓ) which are any one or more selected from sulfur dioxide (SO₂), sulfur trioxide (SO₃), and ions thereof.

The exhaust gas purification filter uses the catalyst having significantly improved catalytic activity described above, whereby harmful exhaust gas introduced to the inlet may pass through the filter unit, be substantially all removed by an actively occurring catalyst reaction, and be discharged through the outlet.

A supercapacitor according to an exemplary embodiment may include: a negative electrode, a positive electrode, a separator interposed between the negative electrode and the positive electrode, and an electrolyte, wherein any one or more of the negative electrode and the positive electrode include the nickel foam described above.

In an exemplary embodiment, the negative electrode and the positive electrode may include an electrode active material supported on the nickel foam, and the electrode active material may include, as an example, active carbon, carbon nanotubes, or graphene.

In an exemplary embodiment, the electrolyte may be one selected from the group consisting of acid-based electrolytes including sulfuric acid, alkali-based electrolytes including calcium hydroxide, and neutral electrolytes including sodium sulfate, but is not limited thereto. For example, the electrolyte may be 1M KOH.

In an exemplary embodiment, the separator may be a porous film including polyethylene or polypropylene, a fiber non-woven fabric including cellulose, polyester, or polypropylene, or a glass fiber (GF), but is not limited thereto.

Since the nickel foam according to an exemplary embodiment has a high specific surface area and also a merit of high electrical conductivity, a supercapacitor having excellent performance may be provided when the nickel foam is applied to the supercapacitor.

In addition, the supercapacitor uses the nickel foam described above having excellent hydrophilicity and hierarchical pore structure as a current collector for an electrode, thereby directly supporting an electrode active material in the pores of the nickel foam without using a polymer-based binder which is conventionally used nonconductor. Since interfacial resistance between the active material and the current collector or between the active material and the electrolyte is decreased to decrease electrode resistance by not using the binder, an ultra-high capacity supercapacitor capable of high rate charging and discharging and shortening of a production process of an electrode may be implemented.

A method of producing a nickel foam having a hierarchical pore structure may include: a first step of charging a nickel foam into a reactor; and a second step of heating the reactor to a temperature of 300° C. or higher and introducing an etching gas to react the nickel foam.

In an exemplary embodiment, acid-treating and washing the nickel foam before the first step may be further included, thereby removing oxides or other contaminants present on the surface of the nickel foam. Specifically, drying after the acid-treating and washing may be further included. As a more specific example, it may be soaking the nickel foam in a hydrochloric acid solution, washing by sonication for 5 minutes to 1 hour, and then drying at room temperature, and other methods may be adopted as long as they do not depart from the scope of the present disclosure.

In an exemplary embodiment, the nickel foam charged into the reactor in the first step is not limited, whether it is produced by a person skilled in the art with common technical knowledge or is a commercially available foam, and as an example, it may be a nickel foam having only inherent macropores having a size of 100 μm to 900 μm.

In an exemplary embodiment, the etching gas of the second step may be a nitrogen-containing gas. A nickel foam having a hydrophilic surface doped with nitrogen may be produced by etching with the nitrogen-containing gas, and thus, when it is applied to an electrochemical reaction, an electrochemically active area may be greatly increased and a material diffusion rate may be increased to improve electrochemical performance.

In an exemplary embodiment, the nitrogen-containing gas may be basic in a solution, and specifically, may be ammonia gas. Since corrosion may proceed in not only the surface of the skeleton but also the inside of the nickel foam by etching with ammonia gas, a nickel foam having a well-developed hierarchical pore structure which includes additional pores having a size of 4 μm or less in addition to the inherent macropores, as well as having a nitrogen-doped hydrophilic surface may be produced.

In an exemplary embodiment, in the second step, the etching gas may be introduced with heating or the etching gas may be introduced after heating, and preferably, the etching gas may be introduced simultaneously with heating to react the nickel foam.

In an exemplary embodiment, the heating in the second step may be performed at a temperature of 300° C. or higher, 400° C. or higher, 500° C. or higher, 600° C. or higher, 700° C. or higher, or 800° C. or higher and 1,100° C. or lower or 1000° C. or lower, and preferably, may be performed at a temperature of 600° C. to 1,100° C., more preferably 700° C. to 1000° C. By etching with ammonia gas with heating in the above range, a hierarchical pore structure including pores having a size of 4 μm or less in addition to inherent macropores may be well developed to produce a nickel foam having a significantly large specific surface area.

Specifically, the reaction is performed at a temperature raised in the second step under the introduced etching gas, and the reaction time may be appropriately changed depending on the temperature. For example, when the reaction is performed at 900° C., it is preferred that the reaction time is 1 hour to 3 hours in terms of producing a nickel foam having desired physical properties, but the present disclosure is not necessarily limited thereto.

In an exemplary embodiment, the etching gas may be introduced to the reactor at a flow rate of 100 sccm to 500 sccm, and specifically, may be introduced at a flow rate of 200 sccm to 400 sccm, but is not necessarily limited thereto.

The method of producing a nickel foam having a hierarchical pore structure according to an exemplary embodiment may further include a third step of washing the nickel foam after the second step, and the washing may be performed by a method commonly used by a person skilled in the art and preferably a weak acid may be used. Impurities formed on the skeleton surface and/or in the inside of the nickel foam by etching with ammonia in the second step are removed by washing of the third step, and thus, a nickel foam having a well-developed hierarchical pore structure which includes additional pores having a size of 4 μm or less in addition to macropores, as well as having a nitrogen-doped hydrophilic surface may be produced.

The nickel foam having the hierarchical pore structure produced using the above production method has a peak at 397.4±1.0 eV in a spectrum by X-ray photoelectron spectroscopy and having a hierarchical pore structure including two or more discontinuous pore distribution peaks in a pore size distribution measured by mercury intrusion porosimetry. Thus, since the nickel foam has a significantly large specific surface area than the conventional nickel foam having only inherent macropores, when it is applied to an electrochemical reaction, an electrochemically active area may be greatly increased and a material diffusion rate may be increased to improve electrochemical performance.

Furthermore, according to the production method, a nickel foam having the hierarchical pore structure described above may be produced by a simple method of treating a nickel foam having only inherent macropores which is a commercialized form with an etching gas under a high temperature of 300° C. or higher.

Hereinafter, the examples and the experimental examples will be illustrated in detail. However, the examples and the experimental examples described later are only illustrative of some, and the technology described in the present specification is not construed as being limited thereto.

[Method of Evaluating Physical Properties]

1. Analysis of Structural and Physical Properties

X-ray photoelectron spectroscopy (XPS) data was performed by an AXIS-NOVA spectrometer available from Kratos using a monochromated Al Kα X-ray source. A pore size distribution by mercury intrusion porosimetry (MIP) was performed using an autopore series available from Micromeritics. X-ray powder diffraction (XRD) was performed by Smartlab X-ray diffraction analysis equipment available from Rigaku using Cu-Kα at 0.15406 nm under the conditions of 40 kV/15 mA/4° min⁻¹ with a solid phase detector. A contact angle was measured using a contact angle measuring instrument DSA100 available from KRUSS in accordance with ASTM D5946. The digital photograph of water droplets on the surface was collected by a SONY digital camera.

2. Analysis of Electrochemical Properties

Electrochemical properties were measured by potentiostat VMP3 available from Biologic at room temperature. A working electrode, a reference electrode, and a counter electrode used herein were the nickel foam (0.5 cm×0.5 cm), an Ag/AgCl (saturated KCl) electrode, and a Pt wire produced according to the examples and the comparative examples, respectively. In order to obtain a consistent data using a cyclic voltammetry (CV), linear sweep voltammetry (LSV) was performed at a scan speed of 1 mVs⁻¹ after pretreating an electrode for 20 cycles. Electrochemical impedance spectroscopy (EIS) was performed in a range of 100 kHz to 0.1 Hz. Chronopotentiometric measurement was performed at a current density of 10 mA/cm² or 100 mA/cm². The potentials of all electrodes were corrected with a reversible electrode (RHE) according to a Nernst equation and were iR-corrected. The overpotential of OER (rioER) was calculated by a difference between a potential in an equilibrium condition (1.23 V) and a potential by the correction (E_{RHE}) and is the following Equation 1:

η_{OER}=E_{RHE}−1.23 V [Equation 1]

A double-layer capacitance (C_{dl}) of the working electrode was measured at various scan speeds (20 to 100 mV·s⁻¹), and was estimated in a potential range of 1.02 V to 1.14 V (vs. RHE) using a CV curve in a non-Faraday region in OER and estimated in a potential range of 0.0502 V to 0.1702 V (vs. RHE) in HER. A Tafel slope was calculated by the following Equation 2:

η=b log j+a [Equation 2]

wherein η is an overpotential, b is a Tafel slope, and J is a current density.

### Example 1

An untreated nickel foam having an areal density of 320±20 g·m ⁻² and a thickness of 1.5 mm (Taiyuan Lizhiyuan Battery Material Co. from China) was prepared at a size of 4 cm×4 cm. The untreated nickel foam was soaked in a 1.0M hydrochloric acid (HCl) solution for 1 hour and washed twice or more with ethanol and deionized water, respectively to prepare a nickel foam from which a surface oxide layer and other contaminants had been removed. Thereafter, the nickel foam from which the surface oxide layer and the like had been removed was heated at a rate of 5° C.·min⁻¹ under ammonia (NH₃) gas (flow rate: 300 sccm) and fired at 900° C. for 1 hour to perform a NH₃ treatment. The NH₃-treated nickel foam was washed with an ethanol aqueous solution mixed at a volume ratio of 1:1 to finally produce a NH₃-treated nickel foam (indicated as hNF or NF-900 in the drawing).

### Example 2

A NH₃-treated nickel foam (indicated as NF-700 in the drawing) was produced in the same manner as in Example 1, except that the firing was performed for 1 hour at 700° C., not 900° C.

### Example 3

A NH₃-treated nickel foam (indicated as NF-1100 in the drawing) was produced in the same manner as in Example 1, except that the firing was performed for 1 hour at 1100° C., not 900° C.

### Comparative Example 1

The following experimental example was performed using an untreated nickel foam (indicated as NF in the drawing) used in Example 1.

### Comparative Example 2

A NH₃-treated nickel foam (indicated as NF-300 in the drawing) was produced in the same manner as in Example 1, except that the firing was performed for 1 hour at 300° C., not 900° C.

### Comparative Example 3

A NH₃-treated nickel foam (indicated as NF-500 in the drawing) was produced in the same manner as in Example 1, except that the firing was performed for 1 hour at 500° C., not 900° C.

### Comparative Example 4

A N₂-treated nickel foam was produced in the same manner as in Example 1, except that the firing was performed under nitrogen (N₂) gas, not NH₃ gas.

### Comparative Example 5

A H₂-treated nickel foam was produced in the same manner as in Example 1, except that the firing was performed under hydrogen (H₂) gas, not NH₃ gas.

### Comparative Example 6

An Ar-treated nickel foam was produced in the same manner as in Example 1, except that the firing was performed under argon (Ar) gas, not NH₃ gas.

### <Experimental Example 1> Analysis of Pore Structure

An effect of the ammonia treatment at a high temperature on a pore structure was confirmed through a pore size distribution by (1) a scanning electron microscope (SEM), (2) a focused ion beam scanning electron microscope (FIB SEM), (3) a focused ion beam ion channeling contrast (FIBICC), and (4) mercury intrusion porosimetry (MIP).

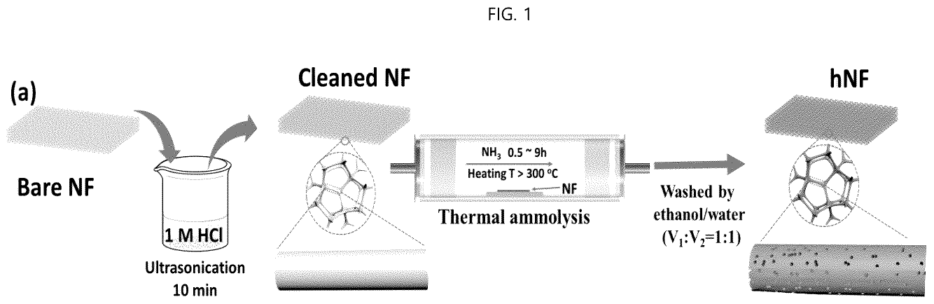

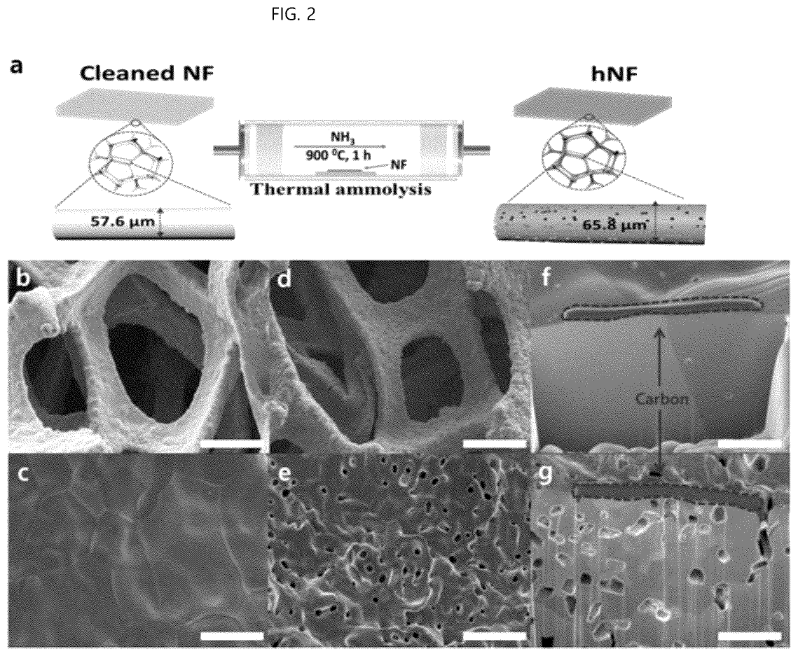

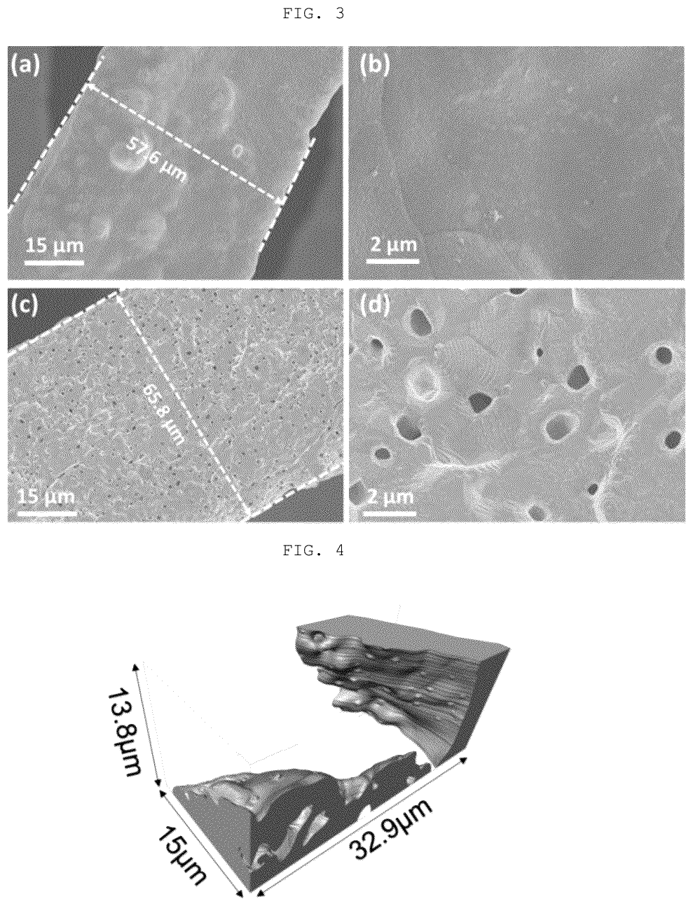

FIG. 1 is a schematic diagram showing a synthesis process of a nickel foam according to an exemplary embodiment having a hierarchical pore structure. a of FIG. 2 is a schematic diagram showing an ammonia treatment process at a high temperature in the method of producing a nickel foam according to Example 1. b of FIG. 2 and c of FIG. 2 are SEM images of the untreated nickel foam of Comparative Example 1, and d of FIG. 2 and e of FIG. 2 are SEM images of the NH₃-treated nickel foam of Example 1. f of FIG. 2 and g of FIG. 2 are FIB SEM images of sections of the nickel foams produced according to Comparative Example 1 and Example 1, respectively. (a) and (b) of FIG. 3 are enlarged SEM images of the skeleton part of the untreated nickel foam of Comparative Example 1, and (c) and (d) of FIG. 3 are enlarged SEM images of the skeleton part of the ammonia-treated nickel foam of Example 1.

Referring to FIG. 2, it is shown that the untreated nickel foam of Comparative Example 1 had inherent macropores in a range of 100 μm to 300 μm together with the hard skeleton of the nickel foam. In addition, it is shown that the nickel foam of Comparative Example 1 had grain boundary lines which border a clean and smooth Ni skeleton surface and each crystal grain.

Meanwhile, it is shown that the NH₃-treated nickel foam of Example 1 had a rough surface differently from the smooth surface of the untreated nickel foam, and numerous pores having a size of 300 nm to 900 nm were produced on the surface of the skeleton of the nickel foam.

In addition, comparing the FIB SEM images of the nickel foams produced according to Comparative Example 1 and Example 1, it is shown that the nickel foam of Comparative Example 1 had a smooth section having no pore development, while the nickel foam of Example 1 had pores developed on the section of the nickel foam. Thus, since pores generated on the skeleton of the nickel foam having a hierarchical pore structure according to an exemplary embodiment are highly likely to be interconnected to be open pores, a reactant and a product may be easily diffused during an electrochemical reaction.

In addition, referring to FIG. 3, it is confirmed that the skeleton thickness of the nickel foam according to Example 1 was increased from 57.6 μm to 65.8 μm as compared with the untreated nickel foam according to Comparative Example 1, and numerous pores having a size of 300 nm to 900 nm were produced.

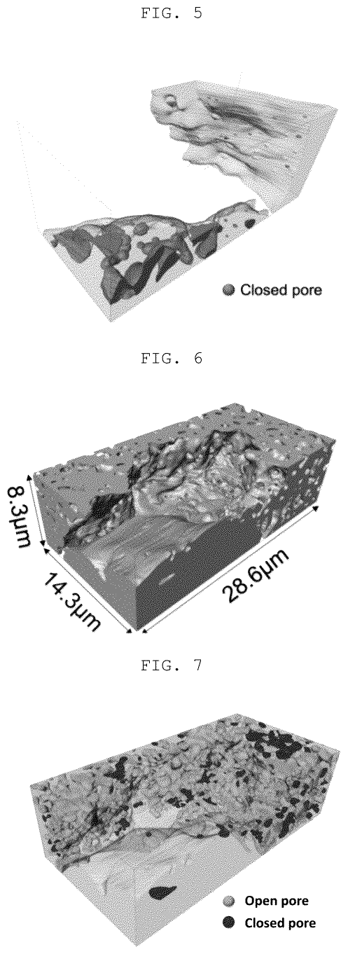

Next, FIGS. 4 to 7 are FIBICC images taken to confirm whether the nickel foams of Comparative Example 1 and Example 1 include open pores. FIGS. 4 to 6 are visualized and quantified images of the representative three-dimensional pore structure having the size shown in the drawings by the FIB serial sectioning of the nickel foams of Comparative Example 1 and Example 1, respectively. FIGS. 5 to 7 are drawings showing the open/closed pore structures of the nickel foams of Comparative Example and Example 1, respectively.

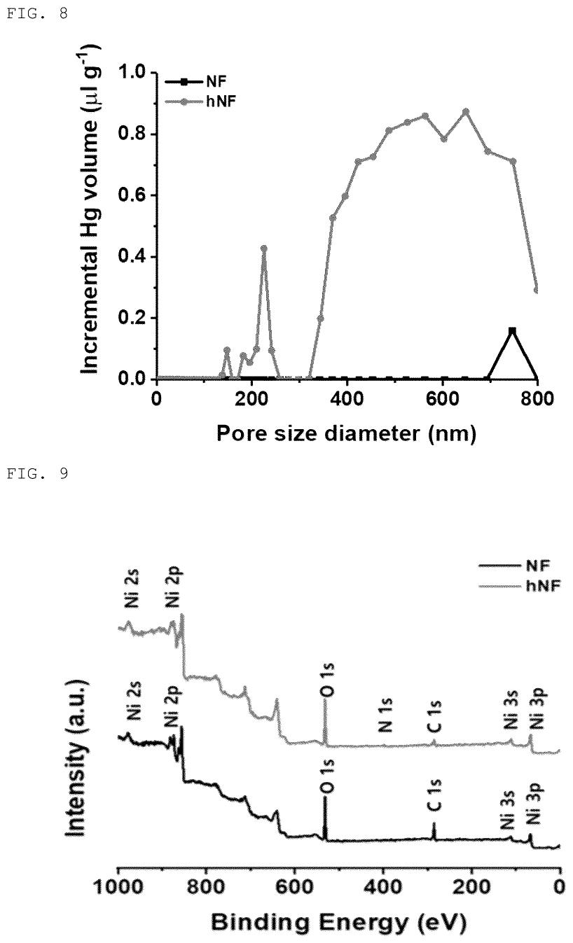

Referring to FIGS. 5 and 7, it is shown that numerous pores were generated on the skeleton of the nickel foam of Example 1 and 90% of the pores generated on the skeleton were open pores, while open pores were not observed in the nickel foam of Comparative Example 1. In the case of the open pores, pores generated on the surface of the nickel foam are highly likely to be interconnected through a pore channel in the skeleton, and thus, efficient diffusion of the reactant and the product as well as a larger surface area is induced, and excellent electrochemical performance for the nickel foam having a hierarchical pore structure according to an exemplary embodiment is expected.

Finally, FIG. 8 is a drawing showing pore size distributions of the nickel foams of Comparative Example 1 and Example 1. Referring to FIG. 8, the nickel foam of Example 1 has various pores in a range of 200 nm to 800 nm, but the nickel foam of Comparative Example 1 had almost no smaller pores in addition to a few pores in a range of 700 nm to 800 nm. Specifically, it is shown that the nickel foam of Example 1 had pores having an average pore size of about 200 nm and about 600 nm in addition to inherent macropores having a size of 100 μm to 300 μm, and thus, had a hierarchical pore structure. Since the nickel foam having a hierarchical pore structure according to an exemplary embodiment had pores which were further generated on the skeleton by a high-temperature ammonia treatment, its surface area was increased, and thus, the activity of the electrochemical reaction was increased.

### <Experimental Example 2> XPS Analysis of Produced Nickel Foam

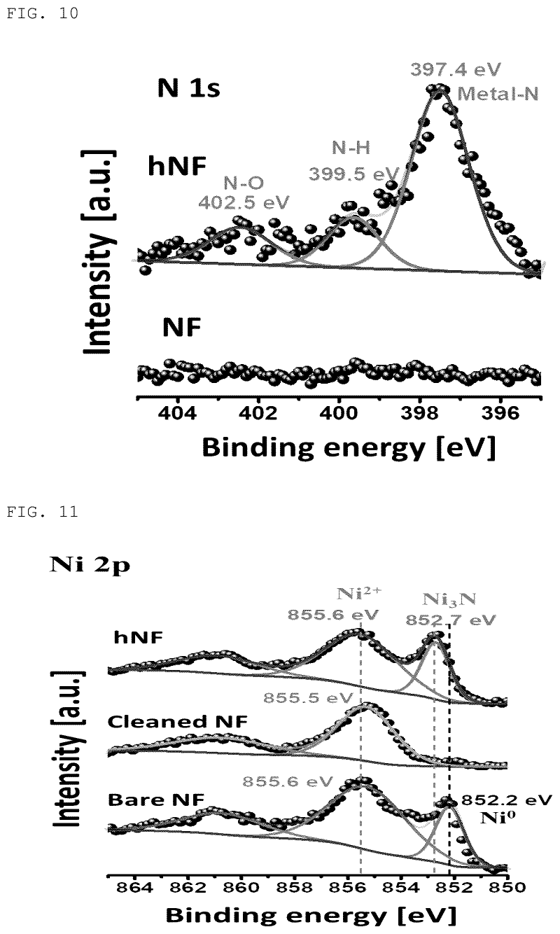

X-ray photoelectron spectroscopy (XPS) was performed in order to investigate the chemical state and the element composition of the surface of the nickel foam, and the results are shown in FIGS. 9 to 11.

Referring to FIG. 9, Ni, C, and O elements were included in the XPS spectrum of the nickel foam of Comparative Example 1, while an N element was included together with Ni, C, and O in the nickel foam of Example 1. Since the untreated nickel foam was ammonia-treated at a high temperature, the N element was present in the nickel foam of Example 1.

FIG. 10 is N is spectra of Example 1 and Comparative Example 1, and referring to this, a main peak was observed at 397.4 eV from a N-Ni bond and additional peaks were observed at 399.5 eV from a N—H bond and 402.5 eV from a N-O bond. N present on the surface of the nickel foam of Example 1 was bonded to Ni to form Ni₃N.

FIG. 11 is a drawing showing Ni 2p spectra of the nickel foam of Example 1, the nickel foam of Comparative Example 1 (indicated as Bare NF in FIG. 11), and the nickel foam from which a surface oxide layer and other contaminants had been removed (indicated as Cleaned NF in FIG. 11). Referring to FIG. 11, the three nickel foams commonly had a peak near about 855.6 eV, which corresponds to Ni 2+. Meanwhile, the nickel foam of Example 1 had a peak at 852.7 eV which was not found in the Bare NF and Cleaned NF, and the peak is interpreted as corresponding to Ni₃N seen in the N is XPS spectrum. The peak at 852.2 eV was observed only at Bare NF, which is considered as corresponding to Ni⁰, that is, a Ni metal, and considering that it was not observed in the cleaned NF and the nickel foam of Example 1, it is seen that the nickel metal was dissolved and oxidized in the process of cleaning the nickel foam to be changed to Ni²⁺.

### <Experimental Example 3> Analysis of Effect of Temperature and Time

Examples 1 to 3 and Comparative Examples 2 and 3 were performed in order to confirm the effect of temperature on the formation of the hierarchical pore structure, and the untreated nickel foam was reacted at various temperatures of 300° C. to 1100° C. for 1 hour while ammonia gas was flowed. FIG. 12 is SEM images of the nickel foams produced at each temperature, in which a of FIG. 12 is an SEM image of the untreated nickel foam of Comparative Example 1, b of FIG. 12 is an SEM image of the nickel foam treated at 300° C. of Comparative Example 2, c of FIG. 12 is an SEM image of the nickel foam treated at 500° C. of Comparative Example 3, d of FIG. 12 is an SEM image of the nickel foam treated at 700° C. of Example 2, e of FIG. 12 is an SEM image of the nickel foam treated at 900° C. of Example 1, and f of FIG. 12 is an SEM image of the nickel foam treated at 1100° C. of Example 3. The scale bar of FIG. 12 was 5 μm.

Referring to b of FIG. 12 and c of FIG. 12, when a heat treatment was performed at a temperature of 500° C. or lower for 1 hour, a rough surface was produced, but pores were not produced on the skeleton of the nickel foam. Referring to d of FIG. 12, the nickel foam treated at 700° C. started to produce some small pores having a size of about 400 nm along the crystal grain boundary. Referring to e of FIG. 12, in the nickel foam treated at 900° C., pores having a size of about 800 nm were distributed uniformly on the skeleton. Thus, it is shown that at the beginning of the ammonia treatment at 900° C., numerous small pores started to be generated along the chemically/structurally weak crystal grain boundary, and more pores grew after 1 hour, so that pores were widely generated throughout the skeleton of the nickel foam. Referring to f of FIG. 12, it is shown that the nickel foam treated at 1100° C. had a pore size increased to about 2 μm to 3 μm, while having a decreased number density of pores. However, when the nickel foam was treated with ammonia for a longer reaction time of 3 hours, 5 hours, or the like, not 1 hour, the nickel foam having a hierarchical pore structure according to an exemplary embodiment may be produced even at a temperature of 700° C. or lower.

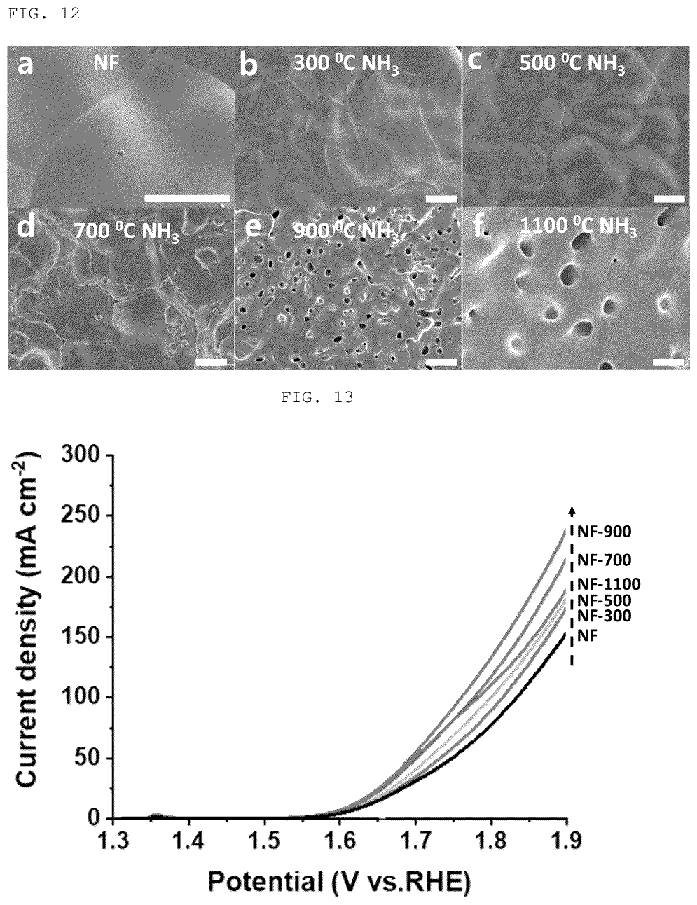

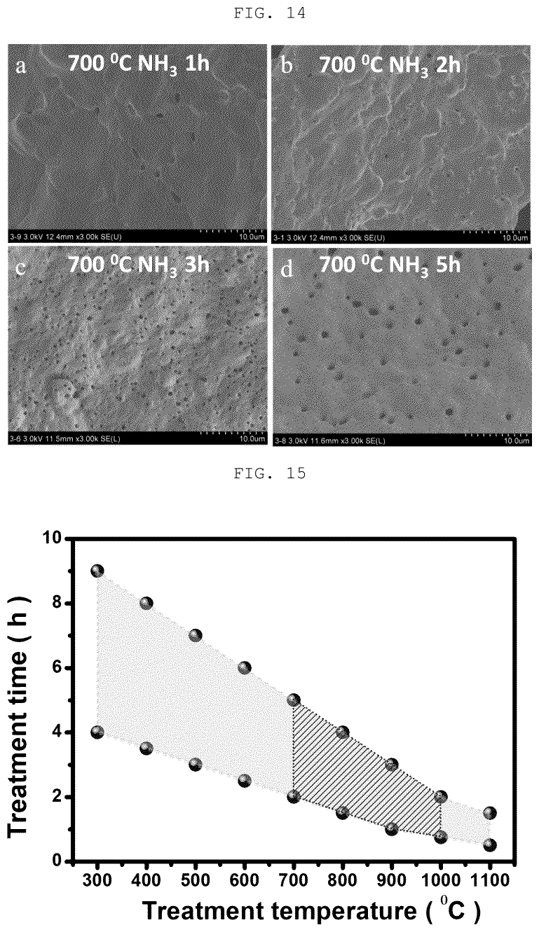

FIG. 13 shows OER catalytic activity curves (non-iR correction) for the ammonia-treated nickel foams of Examples 1 to 3 and the nickel foams of Comparative Examples 1 to 3. Referring to FIG. 13, the nickel foam treated at 900° C. showed the best OER activity.

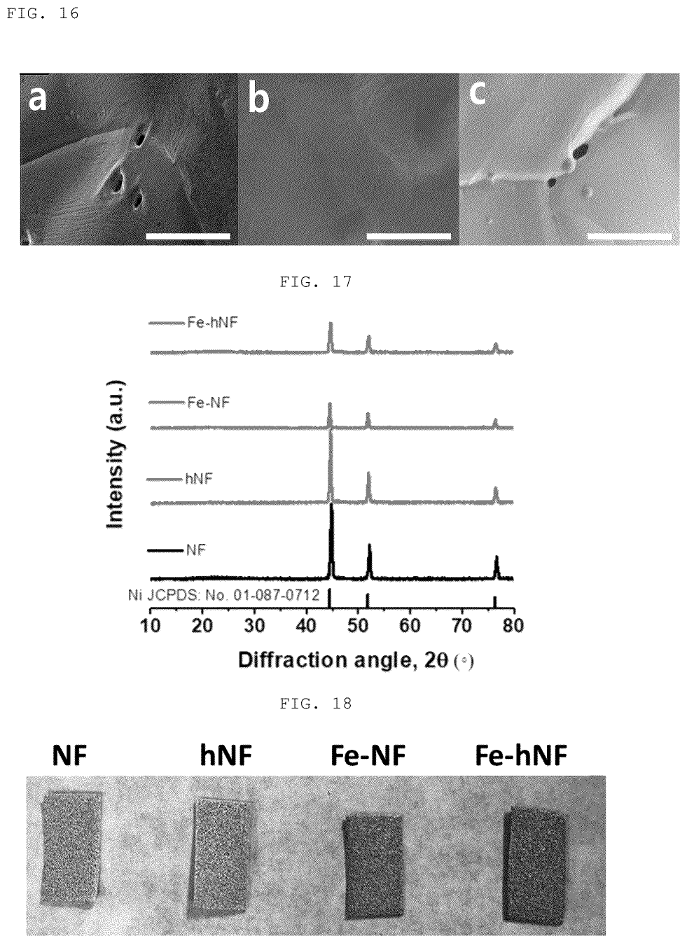

Next, in order to confirm the effect of temperature and time on the formation of the hierarchical pore structure, the treatment was performed in a NH₃ gas flow at various temperatures of 300° C. to 1100° C. in various time ranges. FIG. 14 is SEM images of a nickel foam produced by treatment with ammonia gas at 700° C. at different times. a of FIG. 14, b of FIG. 14, c of FIG. 14, and d of FIG. 14 show the results of treatments for 1 hour, 2 hours, 3 hours, and 5 hours, respectively. Referring to FIG. 14, the nickel foam treated for 1 hour had pores generated along the crystal grain boundary, and the nickel foam treated for 3 hours had pores having a broad and uniform distribution in a range of 500 nm to 1 μm throughout the skeleton of the nickel foam. As the treatment time increased to 5 hours, the size of generated pores was increased to about 1 μm to 1.5 μm, but the number density of the pores tended to be decreased. Meanwhile, even when the treatment time was increased to 7 hours, there was no noticeable change except slight pore expansion, but as the treatment time increased, it was confirmed that the nickel foam had decreased flexibility and became brittle. As a result, when an ammonia treatment was performed at 700° C. for 3 hours, a similar nickel foam which may show electrochemical performance shown when treated at 900° C. for 1 hour may be produced. As a result of ammonia treatments at various temperatures and times, a treatment time range in which a nickel foam having a hierarchical pore structure having excellent performance at each temperature may be produced was found, and is shown in FIG. 15. Referring to FIG. 15, it is shown that as the reaction temperature was low, a nickel foam having a hierarchical pore structure having excellent performance may be produced with the reaction for a longer period of time. Specifically, at a temperature of 500° C. or lower, additional pores were generated on the skeleton of the nickel foam with the ammonia treatment at a high temperature for 3-4 hours or more, and at a temperature of 500° C. or higher, an excellent hierarchical pore structure was obtained with the treatment for 3 hours or less. In addition, preferably, it was confirmed that a nickel foam having a better hierarchical pore structure was produced in a range of 700° C. to 1000° C. At a temperature of 700° C. or lower, smaller pores were generated on the skeleton of the nickel foam, but a tendency to form channels became weakened, and at a temperature of 1000° C. or higher, the size of the pores generated on the skeleton of the nickel foam was increased and the number density of the pores was lowered, resulting in decreased activity.

### <Experimental Example 4> Analysis of Effect of Type of Gas

Example 1 and Comparative Examples 4 to 6 were performed in order to confirm the effect of the type of gas injected in the high-temperature treatment on the formation of the hierarchical pore structure, in which untreated nickel foams were reacted at 900° C. for 1 hour while flowing ammonia, nitrogen, hydrogen, and argon gases, respectively. a of FIG. 16, b of FIG. 16, and c of FIG. 16 are SEM images of the nickel foams produced according to Comparative Examples 4, 5, and 6, respectively. The scale bar of FIG. 16 was 5 μm. Referring to FIG. 16, a slightly roughened surface was observed in the nickel foams which were heat-treated under nitrogen, hydrogen, and argon gas conditions. In particular, it was confirmed that the surface treated in nitrogen was more roughened. Meanwhile, the nickel foam heat-treated under nitrogen and argon gas conditions had some pores, and some pores were shown only in a structurally/chemically weak boundary line, which was due to a high-temperature treatment. However, as a result of heating for a longer time up to 9 hours under nitrogen and argon gas conditions, a pore structure produced throughout the skeleton was not shown, unlike the ammonia gas conditions. Thus, it is shown that the ammonia gas generated a pore structure which was broadly developed throughout the skeleton of the nickel foam as well as in the boundary of the particles.

### <Experimental Example 5> Production of OER Catalyst

The catalyst in which iron was supported on a nickel foam (hereinafter, referred to as Fe-hNF) of Example 1 and the catalyst in which iron was supported on the nickel foam (hereinafter, referred to as Fe-NF) of Comparative Example 1 were synthesized by a simple method of immersing in an iron precursor solution. Specifically, the nickel foam of Comparative Example 1 or the nickel foam of Example 1 were prepared as piece having a size of 1 cm×2 cm, each piece was immersed in an iron precursor solution made of 10 ml of ethanol and 0.1 g of iron chloride hexahydrate (Iron(III) chloride hexahydrate; 99%, Sigma-Aldrich) at room temperature for 6 hours. Thereafter, the nickel foams were taken out of the iron precursor solution, washed several times with ethanol and deionized water, and dried in an oven at 60° C. to produce Fe-hNF and Fe-NF.

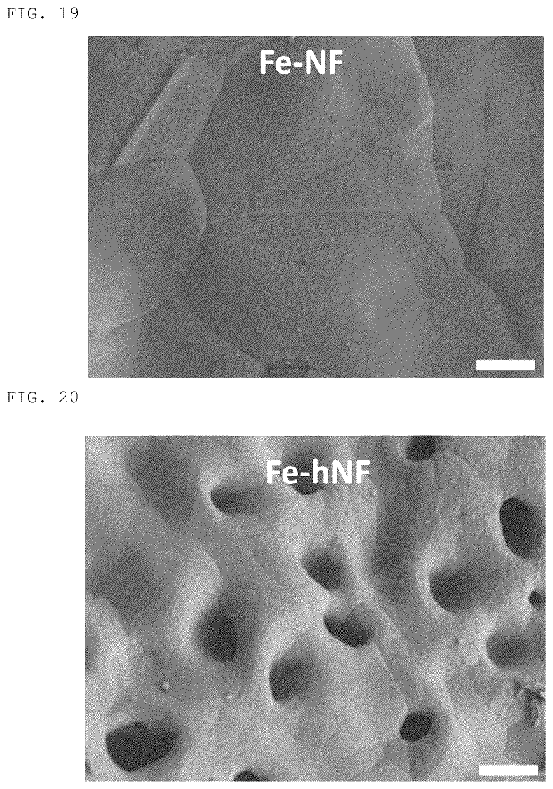

FIG. 17 is XRD patterns of Fe-hNF, Fe-NF, the nickel foam of Example 1 and the nickel foam of Comparative Example 1. Referring to FIG. 17, all of four foams showed only a nickel diffraction peak due to a low loading amount of Fe. FIG. 18 is a photograph of Fe-hNF, Fe-NF, the nickel foam of Example 1 and the nickel foam of Comparative Example 1, and referring it, Fe-hNF and Fe-NF showed a darker color than that before iron loading, and it is shown that some iron metal was deposited on the nickel foam of Example 1 and the nickel foam of Comparative Example 1. FIGS. 19 and 20 are SEM images of Fe-NF and Fe-hNF, respectively, and the scale bar was 1 μm.

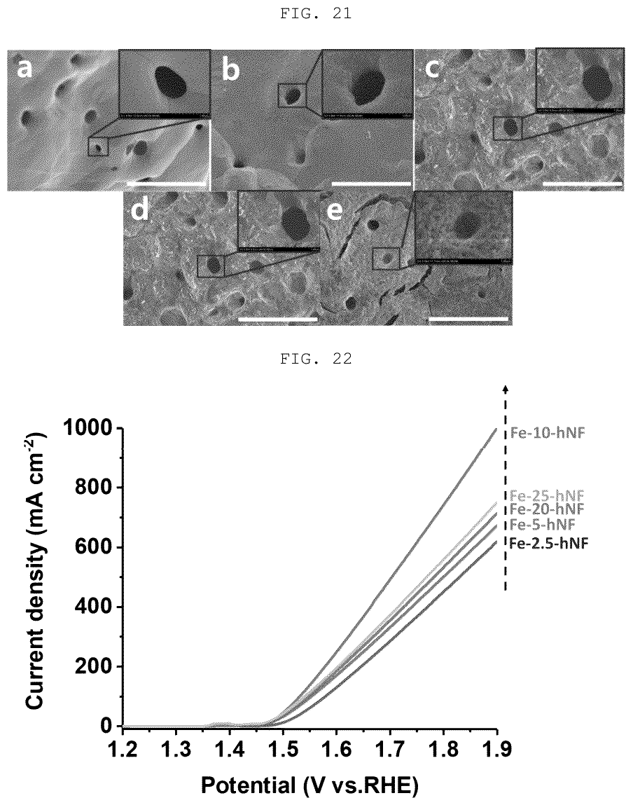

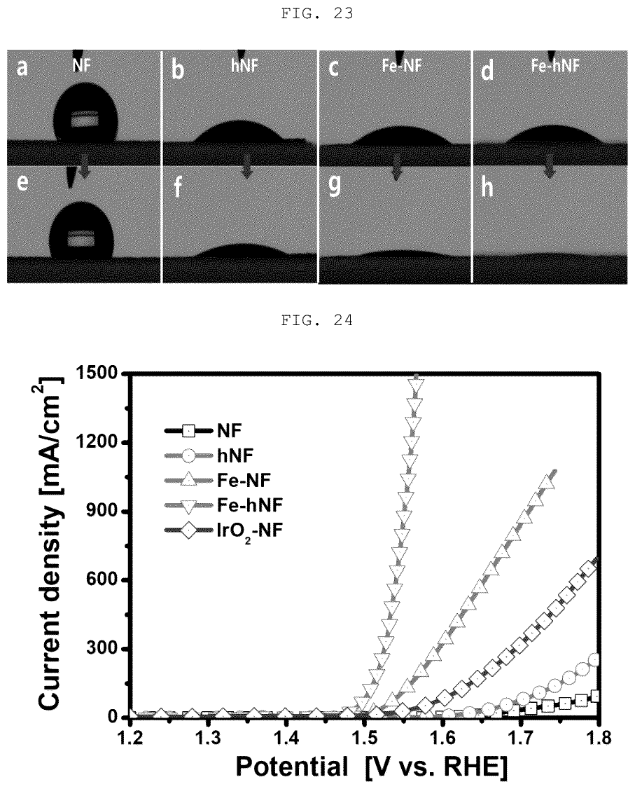

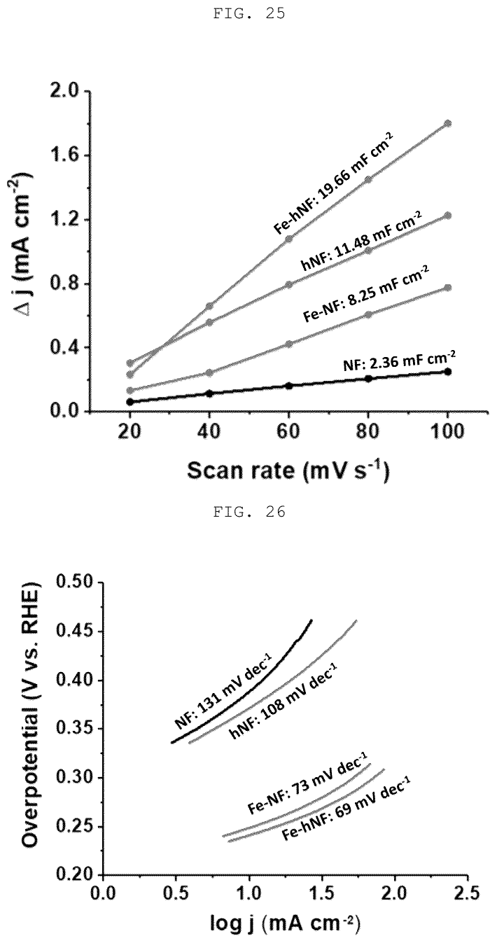

In addition, the effect of the concentration of the iron precursor solution on the pore structure of the nickel foam and the OER catalytic activity was confirmed by varying the concentration, and the results are shown in FIGS. 21 and 22. The concentration of the iron precursor solution was shown as a content of iron chloride hexahydrate per ethanol volume. a of FIG. 21, b of FIG. 21, c of FIG. 21, d of FIG. 21, and e of FIG. 21 are SEM images of the catalysts produced using solutions of 2.5 mg/ml, 5 mg/ml, 10 mg/ml, 20 mg/ml, and 25 mg/ml (hereinafter, referred to as Fe-x-hNF, wherein x is a concentration of the solution), and the scale bar was 5 μm. FIG. 22 is an OER catalytic activity curve (iR correction) of the produced Fe-x-hNF.

Referring to FIG. 22, the OER catalytic activity of Fe-10-hNF was best, and Fe-20-hNF and Fe-25-hNF having a higher concentration of the iron precursor solution showed lower OER catalytic activity. Referring to FIGS. 21 and 22, it is shown that a too high concentration of the iron precursor solution blocked some pores of the nickel foam of Example 1 to decrease the OER catalytic activity.

### <Experimental Example 6> Confirmation of Hydrophilicity of Nickel Foam and OER Catalyst

In order to confirm the hydrophilicity of the nickel foam and the OER catalyst, the water contact angles of the nickel foam of Comparative Example 1, the nickel foam of Example 1, Fe-NF, and Fe-hNF were measured immediately after dropping water and after 60 seconds, and the results are shown in FIG. 23. a of FIG. 23, b of FIG. 23, c of FIG. 23, and d of FIG. 23 are digital photographs of the nickel foam of Comparative Example 1, the nickel foam of Example 1, Fe-NF, and Fe-hNF, which were taken immediately after dropping water, respectively, and e of FIG. 23, f of FIG. 23, g of FIG. 23, and h of FIG. 23 are digital photographs of the nickel foam of Comparative Example 1, the nickel foam of Example 1, Fe-NF, and Fe-hNF, which were taken 60 seconds after dropping water, respectively.

Referring to FIG. 23, the water contact angles of the nickel foam of Comparative Example 1, the nickel foam of Example 1, Fe-NF, and Fe-hNF immediately after dropping water was measured as 119.4°, 62.7°, 61.5°, and 45.9°, respectively. The water droplet on the surface of the nickel foam of Comparative Example 1 maintained almost the same size as an initial water droplet even after 60 seconds, but the water droplets on the surfaces of the nickel foam of Example 1, Fe-NF, and Fe-hNF became flat with the contact angle of almost 0 after 60 seconds. Thus, it is shown that the nickel foam of Comparative Example 1 had a hydrophobic surface, while the nickel foam of Example 1, Fe-NF, and Fe-hNF had a hydrophilic surface. It is shown that Fe-NF had hydrophilicity due to the formation of a hydrophilic Fe(OH)x species on the surface.

The hydrophilicity on the surface of the electrode provided a good contact with an electrolyte, and, in particular, is a characteristic of greatly accelerating bubble separation in the electrochemical reaction generating bubbles such as OER or HER. Thus, as the catalyst is more hydrophilic, an effective active surface area may be improved to improve catalytic activity. It is shown that the water contact angle of Fe-hNF was the lowest, so that charge transfer between the electrolyte and the electrode surface may be promoted and the OER catalytic activity may be improved.

### <Experimental Example 7> Evaluation of OER Catalyst Performance

The performance of the OER catalyst was evaluated by measuring overpotential, an electrochemically active surface area (ECSA), a Tafel slope, and electrochemical impedance and performing a stability test, and all evaluations were performed in an alkaline solution (1.0M KOH).

FIG. 24 is OER catalytic activity curves (iR correction) of Fe-hNF, Fe-NF, the nickel foam of Comparative Example 1, the nickel foam of Example 1, and the nickel foam catalyst on which iridium oxide powder (hereinafter, referred to as IrO₂-NF) was supported.

The IrO₂-NF working electrode was used as a reference catalyst for OER catalyst performance comparison. 5 mg of commercial iridium oxide (IrO₂; 99%, Alfa Aesar), 200 μl of distilled water, 200 μl of isopropanol, and 100 μl of a 5 wt % Nafion binder were mixed for 20 minutes with sonication, and then a produced mixture was drop coated on an untreated nickel foam having a size of 1 cm×1 cm and dried outside to produce an iridium oxide powder-supported nickel foam catalyst (IrO₂-NF).

Fe-hNF had excellent OER catalytic activity with a low overpotential of 266 mV at 100 mA/cm². In particular, it had excellent activity with a low overpotential of 299 mV even at a high current density of 500 mA/cm². Fe-NF, the nickel foam of Comparative Example 1, the nickel foam of Example 1, and IrO₂-NF showed overpotentials of 305 mV, 529 mV, 425 mV, and 360 mV, respectively, at 100 mA/cm².

Next, the electrochemically active surface area was measured based on a double-layer capacitance (Cdi) determined by cyclic voltammetry (CV). FIG. 25 is a graph showing a difference in current density at 1.074 V (vs. RHE) depending on a scan speed, and Cal was obtained from the slope. Referring to FIG. 25, Fe-hNF showed the highest Cdi of 19.66 mF cm⁻², as compared with Fe-NF (8.25 mF cm⁻²), the nickel foam of Example 1 (11.48 mF cm⁻²), and the nickel foam of Comparative Example 1 (2.36 mF cm⁻²). Thus, it is shown that the catalyst in which a transition metal was supported on the nickel foam according to an exemplary embodiment had a large electrochemically active surface area to improve catalytic activity.

In addition, FIG. 26 is Tafel plots of the nickel foam of Comparative Example 1, the nickel foam of Example 1, Fe-NF, and Fe-hNF, in which the Tafel slope of Fe-hNF was 69 mV/dec, which was smaller than those of the nickel foam of Comparative Example 1 (131 mV/dec), the nickel foam of Example 1 (108 mV/dec), and Fe-NF (73 mV/dec). Thus, it is shown that the catalyst in which a transition metal was supported on the nickel foam according to an exemplary embodiment showed efficient mass and charge transfer and rapid OER dynamics.

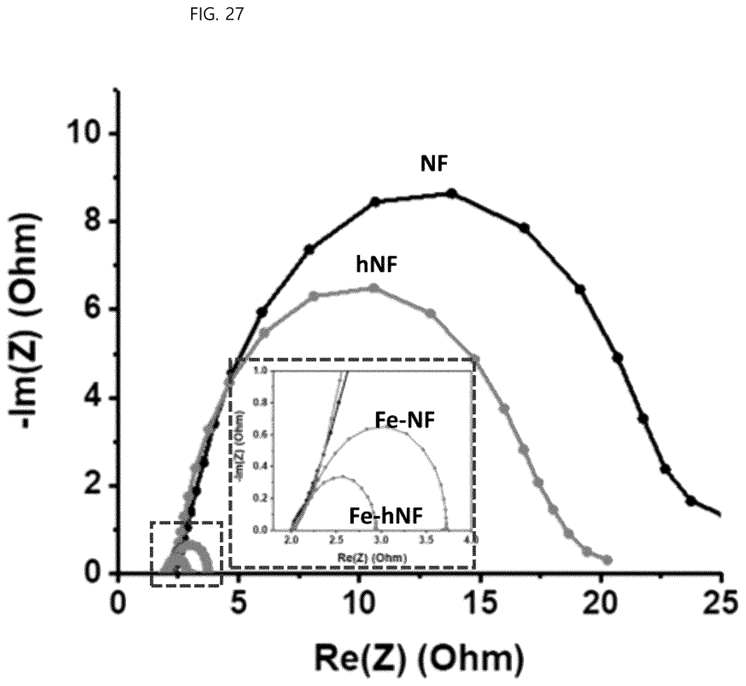

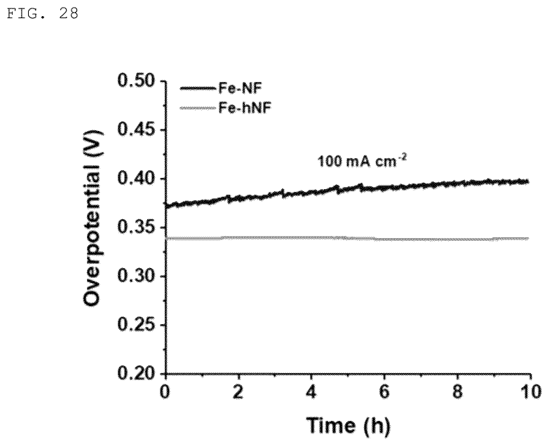

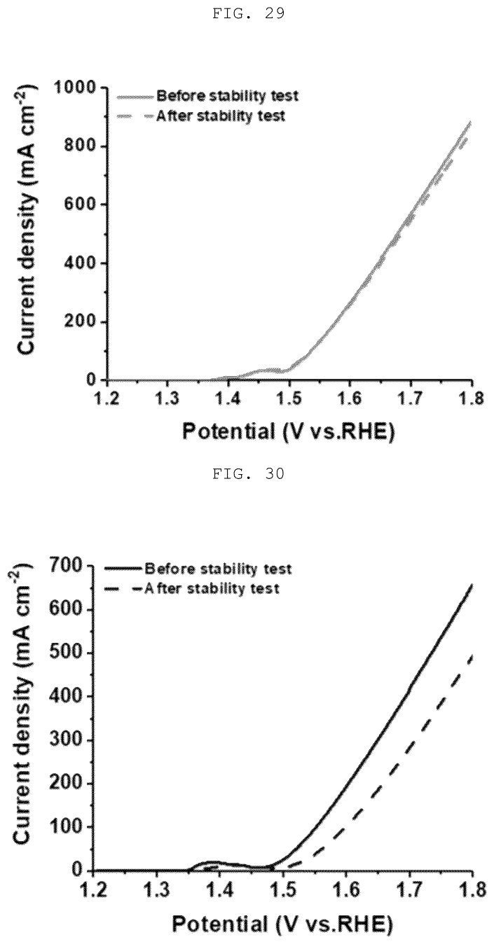

Electrochemical impedance was measured at 1.6 V and is shown in FIG. 27. Referring to FIG. 27, Fe-hNF had the smallest Nyquist plot radius to have lower electron transport resistance related to OER dynamics.

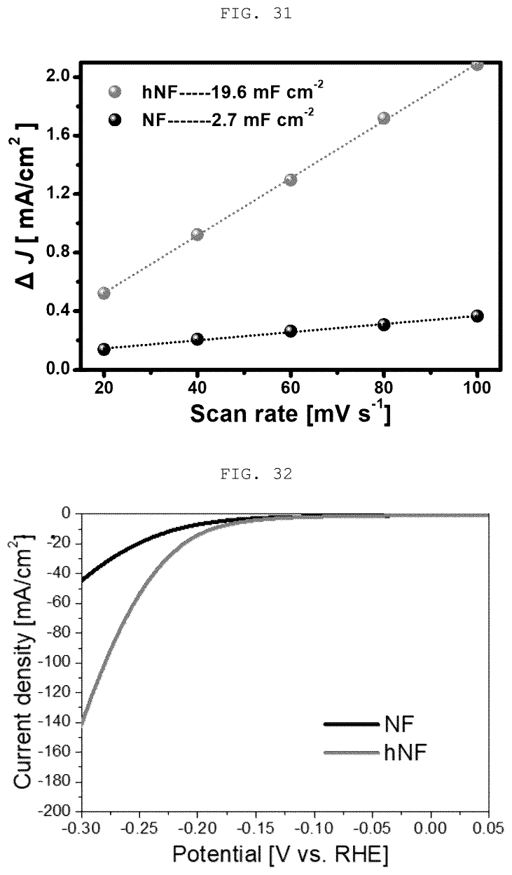

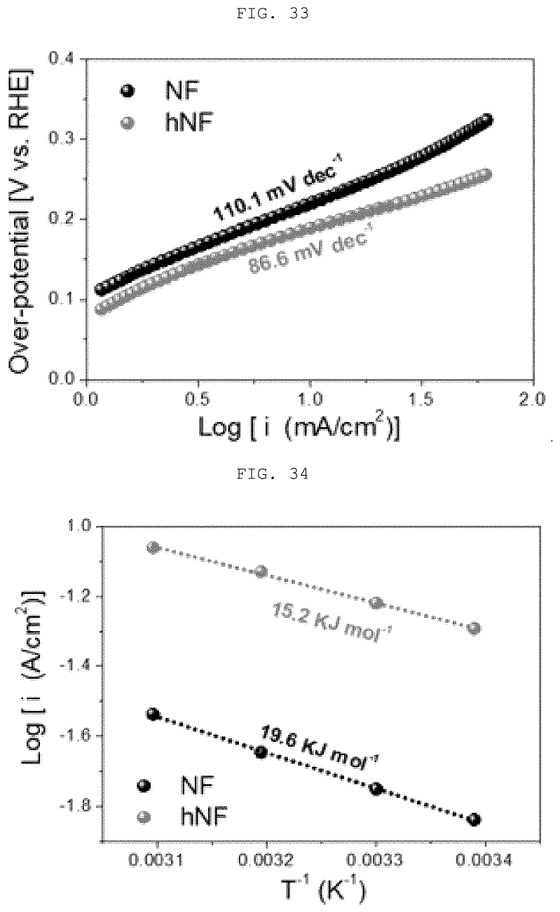

Finally, the stability test was performed by chronopotentiometric measurement at a current density of 100 mA/cm², and the results are shown in FIGS. 28 to 30. FIG. 28 is a graph according to the chronopotentiometric measurement of Fe-NF and Fe-hNF, FIG. 29 is a linear sweep voltammetry (LSV) graph before and after the stability test of Fe-hNF, and FIG. 30 is a LSV graph before and after the stability test of Fe-NF. Referring to them, the overpotential of Fe-NF was increased over time, but the overpotential of Fe-hNF was maintained for 10 hours and it is shown that Fe-hNF had excellent stability.

### <Experimental Example 8> Confirmation of Applicability as HER Catalyst

In order to determine whether the use of the nickel foam having a hierarchical pore structure according to the examples as a HER catalyst is advantageous, C_{dl} in proportion to ESCA was measured, and the results are shown in FIG. 31.

Referring to FIG. 31, the Cdi value of the nickel foam of Example 1 determined at 0.11 V (vs. RHE) was 19.6 mF cm⁻² which was 7 times higher than the nickel foam of Comparative Example 1. Thus, it is shown that the catalyst in which a transition metal was supported on the nickel foam according to an exemplary embodiment had a large electrochemically active surface area to have improved catalytic activity.

Further, the HER performance of the nickel foam having a hierarchical pore structure was evaluated by measuring the overpotential and the Tafel slope, and all evaluations were performed in 1.0M KOH. FIG. 32 is an LSV graph for the nickel foams of Comparative Example 1 and Example 1, and FIG. 33 is a Tafel plot of the nickel foams of Comparative Example 1 and Example 1. The nickel foam of Comparative Example showed an overpotential of 217 mV at 10 mA/cm 2 and a Tafel slope of 110 mV/dec, but the nickel foam of Example 1 had an overpotential of 187 mV and a Tafel slope of 86.6 mV/dec, and thus, it is shown that the HER performance of the examples was better than that of the comparative examples.

Finally, the activation energy of the nickel foams of Comparative Example 1 and Example 1 was measured, and FIG. 34 is Arrhenius plots of the nickel foams of Comparative Example 1 and Example 1, the current density at an overpotential of 250 mV was substituted into the Arrhenius equation, and the activation energy was determined by the slope of the Arrhenius plot. As a result, the activation energy of the nickel foam of Example 1 was 15.2 kJ mol⁻¹, which was lower than that of the nickel foam of Comparative Example 1 of 19.6 kJ mol⁻¹, and thus, it is shown that the nickel foam of the examples is more favorable than the nickel foam of the comparative examples when it is applied to the HER catalyst.

### <Experimental Example 9> Evaluation of HER Catalyst Performance

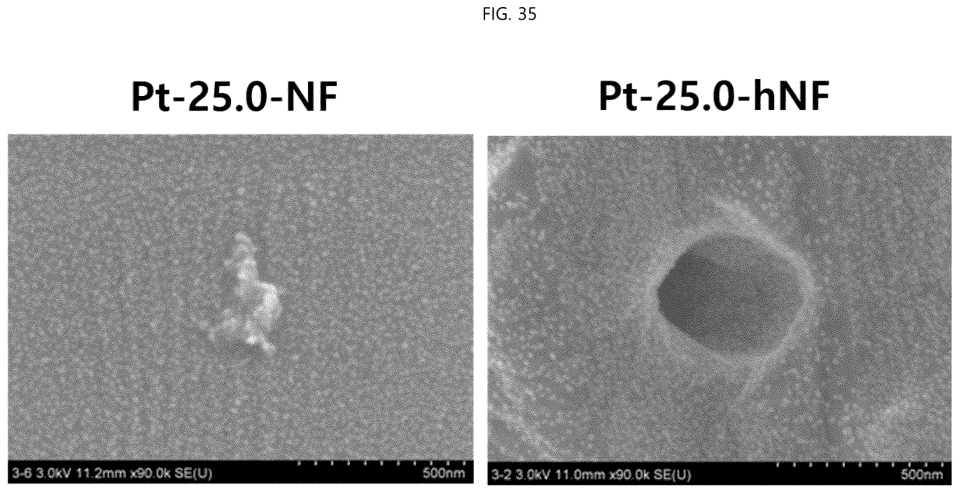

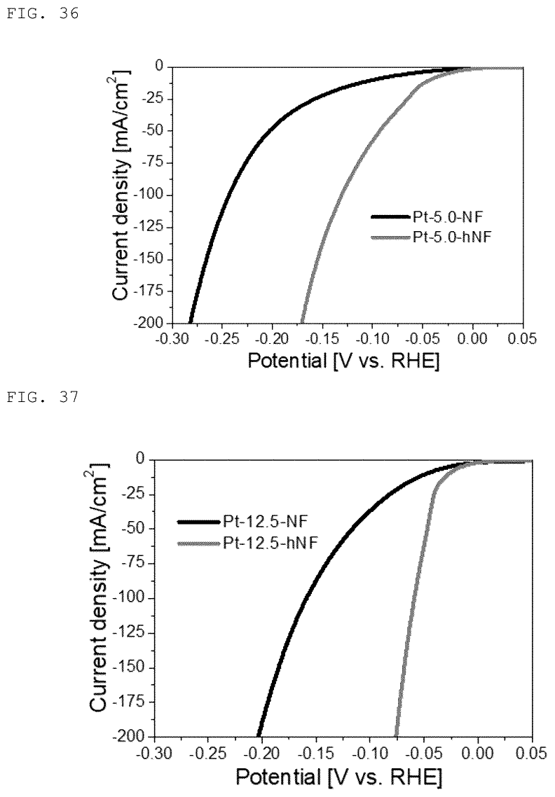

As seen in Experimental Example 8, the nickel foam having a hierarchical pore structure according to the examples had a characteristic of high ECSA and is expected to have high HER performance. Thus, Pt nanoparticles (NP) were deposited to produce a HER catalyst. Specifically, the HER catalyst was produced by an electrochemical reduction process in a standard three-electrode system, in which the nickel foam of Example 1 was used as a working electrode, a Pt wire was used as a counter electrode, and Ag/AgCl (saturated KCl) was used as a reference electrode. The electrochemical reduction process was performed by multi-cycle cathode polarization in 10 mL of a 1.0M KOH solution containing 5.0 μM, 12.5 μM, 25.0 μM, and 50.0 μM H₂P+Cl₆ at a scan speed of 50 mVs⁻¹ in a range of 0 to −0.50 V based on RHE for 200 cycles. The HER catalyst produced at this time was indicated as Pt-5.0-hNF, Pt-12.5-hNF, Pt-25.0-hNF, and Pt-50.0-hNF, respectively depending on the concentration of H₂PtCl₆ used. The same process was performed except that the nickel foam of Example 1 was replaced with the nickel foam of Comparative Example 1, and the produced HER catalyst was indicated as Pt-5.0-NF, Pt-12.5-NF, Pt-25.0-NF, and Pt-50.0-NF. FIG. 35 is SEM images of Pt-25.0-hNF and Pt-25.0-NF, and referring to it, it is confirmed that Pt nanoparticles were distributed not only on the surface of the nickel foam but also to the pores further generated in Pt-25.0-hNF.

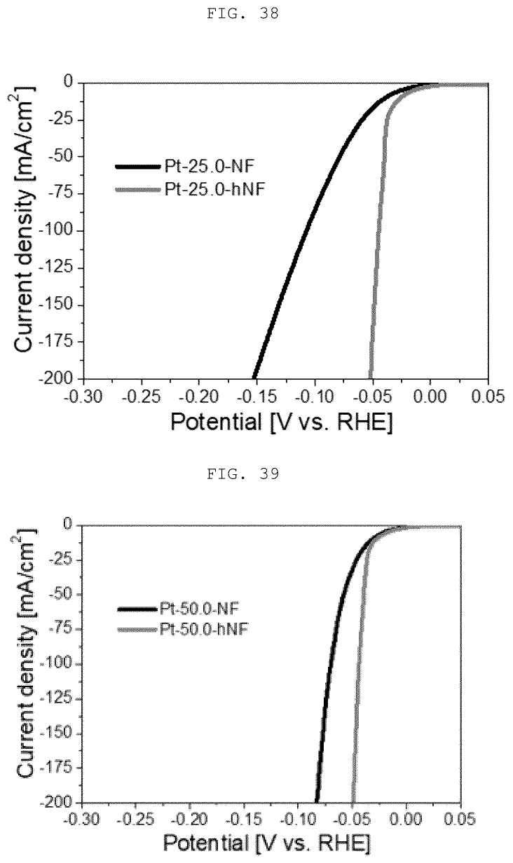

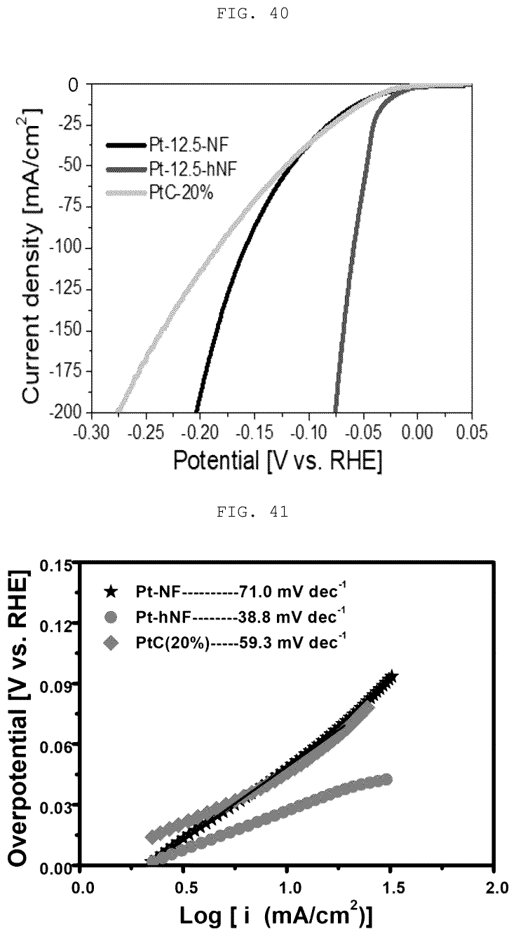

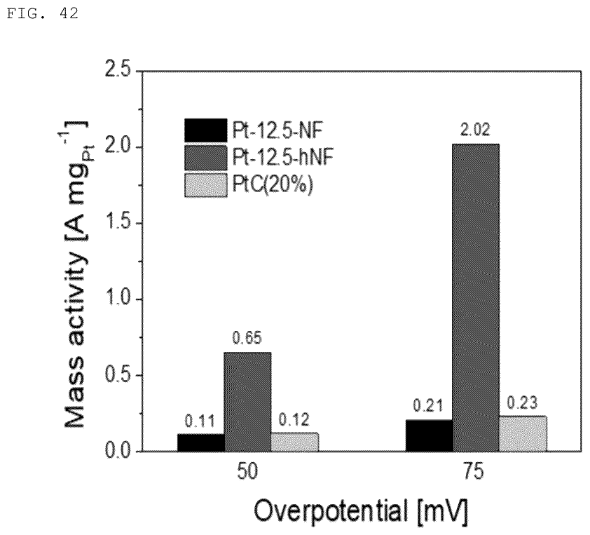

The performance of the HER catalyst was evaluated by LSV in 1.0M KOH, and the results are shown in FIGS. 36 to 39. Referring to it, Pt-5.0-hNF, Pt-12.5-hNF, Pt-25.0-hNF, and Pt-50.0-hNF had overpotentials of 42.0 mV, 24.2 mV, 25.7 mV, and 27.5 mV, and Pt-5.0-NF, Pt-12.5-NF, Pt-25.0-NF, and Pt-50.0-NF had overpotentials of 98.0 mV, 48.1 mV, 38.7 mV, and 31.6 mV, respectively. That is, the HER catalyst using the nickel foam of the examples had excellent performance. In particular, it showed the best performance at a Pt concentration of 12.5 μM.

In addition, the performance of the catalyst was evaluated for Pt-12.5-hNF, Pt-12.5-NF, and commercial Pt/C (20%), and the results are shown in FIGS. 40 to 42. FIG. 40 is an LSV graph for each case, FIG. 41 is a Tafel plot, and FIG. 42 is a graph showing activity per weight (mass activity) calculated in overpotentials of 50 mV and 75 mV.

Referring to FIGS. 40 and 41, Pt-12.5-hNF showed an overpotential of 24.2 mV and a Tafel slope of 38.8 mV/dec, which are lower numerical values than 12.5-NF (48.1 mV, 71 mV/dec) and Pt/C (45.5 mV, 59.3 mV/dec) and showed better HER performance. Referring to FIG. 42, the activity of Pt-12.5-hNF per weight at an overpotential of 50 mV was 0.65 A/mg_{Pt}, which was 5 times higher than those of Pt-12.5-NF and Pt/C (20%), and that at an overpotential of 75 mV was 2.02 A/mg_{Pt}, which was 9 times higher than those of Pt-12.5-NF and Pt/C (20%). The results showed Pt use efficiency significantly improved by using the nickel foam having a hierarchical pore structure according to an exemplary embodiment as a catalyst support.

### <Experimental Example 10> Synthesis of M-hNF Coated with Another Metal (M)

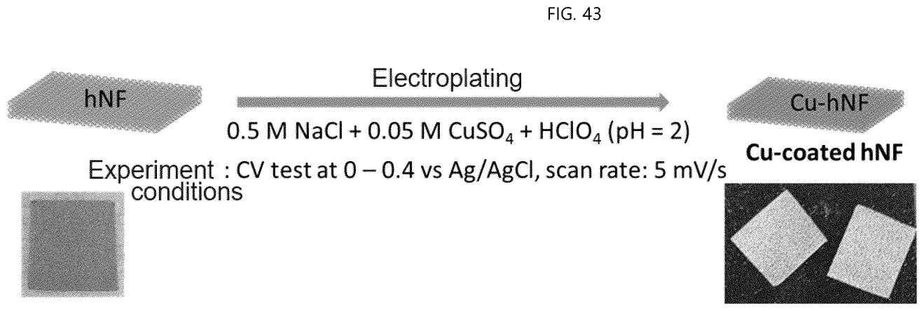

According to FIG. 43 showing the experimental conditions of coating the nickel foam produced according to Example 1 with copper (Cu), 0.05M CuSO₄, 0.5M NaCl, and HClO₄ were mixed so that the pH was 2, thereby preparing a copper precursor solution. A copper-coated nickel foam (or Cu-hNF) was produced by an electrochemical reduction process in a three-electrode system using the copper precursor solution, in which the nickel foam of Example 1 was used as a working electrode, a Pt wire was used as a counter electrode, and Ag/AgCl (saturated KCl) was used as a reference electrode. Specifically, the electrochemical reduction process was performed under 0 V to 0.4 V compared with the Ag/AgCl reference electrode at a scan speed of 5 mVs⁻¹ for 10 cyclic voltammetry (CV) cycles. As a result of observation with the naked eye, it was confirmed that the produced Cu-hNF had a typical orange luster of copper.

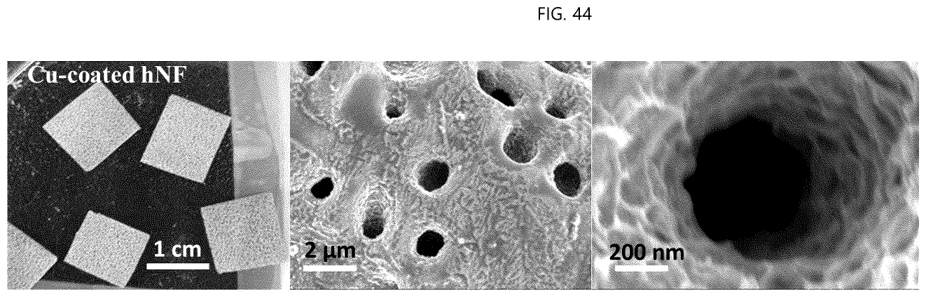

FIG. 44 is SEM images of Cu-hNF, and referring to FIG. 44, it is shown that Cu-hNF still had pores having a diameter of about 1 μm formed on the skeleton of the nickel foam of Example 1, and copper was coated on the surface of the nickel foam. Thus, it is shown that though it was conventionally impossible to produce a Cu foam having a hierarchical pore structure, but the nickel foam coated with copper having a hierarchical pore structure (Cu-hNF) was able to be produced by coating the surface of the nickel foam according to an exemplary embodiment of the present disclosure with copper. In summary, since copper is an example of a metal coated on the nickel foam, a nickel foam having a hierarchical pore structure which is coated with a metal by an electrochemical reduction process using a metal ion solution including any one or more metals selected from gold (Au), silver (Ag), platinum (Pt), ruthenium (Ru), palladium (Pd), tungsten (W), iron (Fe), cobalt (Co), chromium (Cr), manganese (Mn), and molybdenum (Mo) instead of copper may be provided.

The nickel foam according to an exemplary embodiment has a well-developed hierarchical pore structure which further includes pores having a size of 4 μm or less in addition to inherent macropores having a size of 100 μm to 900 μm, and thus, may have a significantly large specific surface area.

In addition, the nickel foam according to an exemplary embodiment has a hydrophilic surface, and when it is applied to an electrochemical reaction, may improve a contact with an electrolyte.

The catalyst according to an exemplary embodiment includes the nickel foam described above, thereby significantly improving catalytic activity.

In addition, when the nickel foam described above is applied to an electrochemical reaction such as a water electrolysis system, an exhaust gas purification filter, and chemical and environmental sensors, an electrochemically active area may be greatly increased and a material diffusion rate may be increased to improve electrochemical performance.

In addition, the nickel foam having the hierarchical pore structure described above may be produced by a simple method of treating a nickel foam having only inherent macropores which is a commercialized form with an etching gas under a high temperature.

Hereinabove, although the present disclosure has been described by the specific matters and limited exemplary embodiments in the present specification, they have been provided only for assisting the entire understanding of the present disclosure, and the present disclosure is not limited to the exemplary embodiments, and various modifications and changes may be made by those skilled in the art to which the present disclosure pertains from the description.

Therefore, the spirit described in the present specification should not be limited to the above-described exemplary embodiments, and the following claims as well as all modified equally or equivalently to the claims are intended to fall within the scope and spirit of the specification.

What is claimed is:

1. A nickel foam which has a peak at 397.4±1.0 eV in a spectrum by X-ray photoelectron spectroscopy and has a hierarchical pore structure including two or more discontinuous pore distribution peaks in a pore size distribution measured by mercury intrusion porosimetry.

2. The nickel foam of claim 1, wherein the nickel foam has a water contact angle of 80° or less on a surface.

3. The nickel foam of claim 1, wherein the nickel foam has a specific surface area of 0.1 m²/g or more.

4. The nickel foam of claim 1, wherein the two or more pore distribution peaks include a first peak having an average pore size between 100 μm and 900 μm and a second peak having an average pore size between 400 nm and 4000 nm.

5. The nickel foam of claim 4, wherein the two or more pore distribution peaks further include a third peak having an average pore size between 100 nm and 300 nm.

6. The nickel foam of claim 1, wherein the nickel foam has pores generated on a skeleton, which have an average diameter 25 times or more smaller than an average diameter of inherent macropores of the nickel foam.

7. The nickel foam of claim 6, wherein the pores generated on the skeleton of the nickel foam include open pores.

8. A catalyst comprising: the nickel foam of claim 1; and a transition metal supported on a surface of the nickel foam.

9. The catalyst of claim 8, wherein the catalyst has a use in an oxygen evolution reaction (OER) or a use in a hydrogen evolution reaction (HER).

10. The catalyst of claim 8, wherein the transition metal is any one or two or more metals selected from the group consisting of group 4 to 12 metals.

11. A water electrolysis system comprising a reaction unit where a water electrolysis reaction occurs,
wherein the reaction unit includes a negative electrode, a positive electrode, and an electrolyte, and
any one or more of the negative electrode and the positive electrode include the catalyst of claim 8.

12. The water electrolysis system of claim 11, wherein the electrolyte is an alkaline aqueous solution or a neutral aqueous solution.

13. An exhaust gas purification filter comprising:
a filter unit including the catalyst of claim 8;
an inlet provided in one side of the filter unit to which gas including harmful exhaust gas is introduced; and
an outlet provided in the other side of the filter unit from which gas from which the harmful exhaust gas has been removed is discharged.

14. A supercapacitor comprising: a negative electrode, a positive electrode, a separator interposed between the negative electrode and the positive electrode, and an electrolyte, wherein any one or more of the negative electrode and the positive electrode include the nickel foam of claim 1.

15. A method of producing a nickel foam having a hierarchical pore structure, the method comprising:
a first step of charging a nickel foam into a reactor; and
a second step of heating the reactor to a temperature of 300° C. or higher and introducing an etching gas to react the nickel foam.

16. The method of producing a nickel foam of claim 15, wherein the etching gas is a nitrogen-containing gas.

17. The method of producing a nickel foam of claim 16, wherein the nitrogen-containing gas shows basic in a solution.

18. The method of producing a nickel foam of claim 16, wherein the nitrogen-containing gas is ammonia.

19. The method of producing a nickel foam of claim 15, wherein the heating is performed at a temperature of 600° C. to 1,100° C.

20. The method of producing a nickel foam of claim 15, wherein the etching gas is introduced to the reactor at a flow rate of 100 sccm to 500 sccm.
